(19) United States
(12) Patent Application Publication
(10) Pub. No.: US 2008/0263194 A1
(43) Pub. Date: Oct. 23, 2008

(54) METHOD AND SYSTEM FOR OPTIMAL BINDING SELECTION FOR SERVICE ORIENTED ARCHITECTURES

(75) Inventors: Jong-Deok Choi, Mount Kisco, NY (US); Kang-Won Lee, Nanuet, NY (US); Sang-Jeong Lee, Seoul (KR); Kyung D. Ryu, New City, NY (US); Dinesh Verma, Mount Kisco, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/736,335

(22) Filed: Apr. 17, 2007

(51) Int. Cl. G06F 15/173

(52) U.S. Cl. 709/224

(57) ABSTRACT

A method for selecting a best performing binding for a server and a client in a service-oriented architecture includes: discovering configuration information about the service and the operating environment of the server and the client; selecting the best performing binding between the client and the server based on the discovered information; enabling the selected binding in a binding proxy for communication between the client and the server.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to service oriented architectures, and more particularly to providing a method, article, and system for selecting the best performing binding for a service and client in a service-oriented architecture using environment information during deployment time or run time.

2. Description of the Related Art

In a distributed computing environment, interactions between distributed objects via remote procedure calls and remote method invocations are common operations. The rapid adoption of service oriented architectures (SOA) by the information technology (IT) industry has made it imperative to provide efficient ways to bind and invoke services dynamically. Web services technology has been developed to bind and invoke services dynamically.

Web services technology represents an important way for businesses to communicate with each other and with clients as well. Unlike traditional client/server models, such as a Web server or Web page system, Web services do not provide the user with a graphical user interface (GUI). Instead, Web services share business logic, data and processes through a programmatic interface across a network. The applications interface with each other, not with the users. Developers can then add the Web service to a GUI (such as a Web page or an executable program) to offer specific functionality to users. The Web services' distributed computing model allows application-to-application communication. For example, a purchase-and-ordering application could communicate to an inventory application that specific items need to be reordered. The remote service invocation is supported via a well-defined service interface, called stubs. The stubs on the callee and the caller sides are either hand-coded or generated using automated tools such as stub compilers. Because of this level of application integration, Web services have grown in popularity and are beginning to improve business processes.

When designing a distributed application, software developers typically choose to implement Web binding using Simple Object Access Protocol (SOAP), Extensible Markup Language (XML), and Hyper Text Transfer Protocol (HTTP) to call the service for location and platform independence. However, this may not be the optimal binding to a service in certain environments. For example, if the service is located on the same network domain (and therefore does not require passing through firewalls) it is better to use a “light weight” protocol such as Java Remote Method Invocation (RMI). Present efforts in Web services development have focused on SOAP and XML processing to improve their performance. However, the conversion between native objects to and from XML strings places inherent overhead. Another solution called Web Service Invocation Framework (WSIF) tries to support multiple bindings to a service by extending the Web Services Description Language (WSDL) schema and providing a client side library to use such facilities. However, this requires software developers to adopt this technology, learn it, and implement with the given libraries. The proposed invention provides a complementary solution, which will work with advanced XML processors and without requiring developers to adopt new paradigms.

### SUMMARY OF THE INVENTION

Embodiments of the present invention include a method, article, and system for selecting a best performing binding for a server and a client in a service-oriented architecture, the method includes: discovering configuration information about the service and the operating environment of the server and the client; selecting the best performing binding between the client and the server based on the discovered information; enabling the selected binding in a binding proxy for communication between the client and the server.

An article comprising machine-readable storage media containing instructions that when executed by a processor enable the processor to selecting the best performing binding for a service and client in a service-oriented architecture using environment information during deployment time or run time, wherein the instructions include: collecting information about an operating environment by a configuration discovery module; determining a best performing binding between a client service and a server with decision logic based on the collected information from the configuration discovery module; implementing the best performing binding with a binding proxy module; and forming stubs by an automated generator based on collected information about possible bindings that the client service can receive.

A system for selecting the best performing binding for a service and client in a service-oriented architecture using environment information during deployment time or run time, the system includes: a configuration discovery module that collects information about an operating environment; decision logic to select the best performing binding among multiple alternatives between service client and server based on the collected information from the configuration discovery module; a binding proxy module that contains the decision logic and implements the bindings, and interacts with the configuration discovery module; a proxy generation module that automatically creates a binding proxy containing multiple bindings while exposing a unified interface; wherein the multiple bindings are created based on WSDLs published by the service; a stub module that facilitates a client module to connect to a remote service using one of the multiple bindings, while presenting a uniform programming interface to a programmer; an automated generator for forming stubs based on collecting information about possible bindings that a service can receive; and decision logic inside the formed stub that communicates with the configuration discovery module to determine the optimal binding for the client and the service.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a binding proxy, and its interaction with an application, a configuration discovery module, and underlying network layers according to an embodiment of the invention.

FIGS. 2A and 2B illustrate a structure for SOAP and IIOP messages

FIG. 3 illustrates a system for implementing embodiments of the invention.

The detailed description explains the preferred embodiments of the invention, together with advantages and features, by way of example with reference to the drawings.

### DETAILED DESCRIPTION

Embodiments of the present invention provide a method, article, and system for selecting the best performing binding for a service and client in a service-oriented architecture using the environment information during deployment time or run time. Embodiments of the invention consist of the following modules and components:
A configuration discovery module that can collect the information about the operating environment, such as the relative location of the client module and the service, and the existence of other constraints (e.g., firewall) between them.
Decision logic to select the best performing binding among multiple alternatives (e.g. SOAP, RMI, JMS, J2EE Connector Architecture (JCA)) between service client and server based on the information from the configuration discovery module.
A binding proxy module that contains decision logic and implements the bindings, and can interact with the configuration discovery module.
A proxy generation module that automatically creates a binding proxy containing multiple bindings while exposing a unified interface; the multiple bindings are created based on the WSDLs published by the service.
A stub module that allows the client module to connect to a remote service using one of several viable bindings, while exposing a uniform programming interface to the programmer.
An automated generator for forming stubs by collecting information about the possible bindings that a service can receive.
Decision logic inside the stub that communicates with the configuration discovery module to determine the optimal binding for the client and the service.

The programming environment employed by embodiments of the invention is an extended software development environment, such as an Eclipse-based development environment, with specialized plug-ins. A plug-in called a binding proxy generator may be utilized for use in embodiments of the invention, which automatically generates a proxy called a binding proxy based on the WSDL file from the service. Essentially the goal of a binding proxy is to hide the different invocation mechanisms between various types of bindings from the application developer.

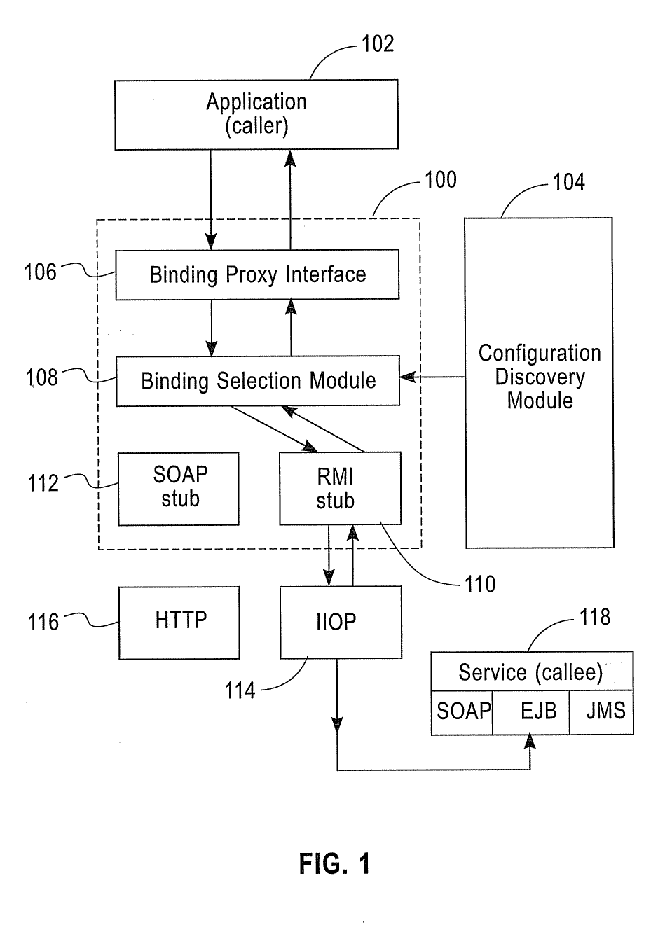

FIG. 1 presents the structure of a binding proxy 100, and its interaction with the application 102, the configuration discovery module 104, and the underlying network layers (114, 116) that interact with the service 118. The binding proxy 100 interacts with the application 102, by exposing simple interfaces to a remote object through the binding proxy interface 106. When the application calls the constructor for a remote object in the client, it retrieves target environment parameters from the configuration discovery module 104. Based on the input from the discovery module 104, the binding proxy 100 makes a decision in binding selection module 108 as to which binding to create. The example in the figure shows the case when an RMI binding has been chosen—in this case, only an RMI stub 110 will be created. Although it has a capability to instantiate a SOAP stub 112, it will not instantiate one. Thus, when deployed, a binding proxy does not incur as much extra overhead in terms of size and performance compared to that of a RMI stub.

We note that the SOAP stub and the RMI stub and the corresponding transport protocols (HTTP and Internet Inter Orb Protocol (IIOP)) that enable a SOAP binding and an RMI binding, respectively, are shown here as examples. The proposed binding proxy can encapsulate any number of various types of bindings as enumerated before (e.g., JCA, JMS).

Using the binding proxy 100, the developer can write an application as if they're writing a standard RMI or SOAP application. Table 1 illustrates an example of creating and accessing a remote object via the binding proxy 100. In the example of Table 1, RemoteObjectFooProxy is a proxy that has been auto-generated by the stub generator using the WSDL file of the RemoteObjectFoo. Creating a handle for that remote object is as simple as just calling the constructor of the proxy. Once the handle is created, it can be used in the same manner as a local instance.

TABLE 1

import RemoteObjectFoo;
// remote object creation
RemoteObjectFoo foo = new RemoteObjectFooProxy( );
// method call
foo.bar( );

In a binding selection scenario, the role of a configuration discovery module 104 is to first identify the types of bindings that the service supports. This information can be found from the extended WSDL published by the service. Then the discovery module 104 needs to determine the relative location of the service and the client—for example, whether they are located in the same Java Virtual Machine (JVM), in the same physical machine, on the same subnet, or connected via wide area network. In addition, it also needs to determine whether there is a firewall between the client and the server. This can be achieved by probing specific network ports. Based on this information, the decision logic 108 in the binding proxy 100 will select an appropriate binding.

If for example the client and server are deployed together in the same Enterprise Archive (EAR) file, then they can communicate via Enterprise Java Bean (EJB) local interface, which is equivalent to making a native Java call. Also if they will be run in the same class loader, they can use EJB local binding. On the other hand, if client and server are deployed on the same JVM but not in the same EAR, then they can communicate via EJB remote interface, with local RMI, which is known to be more efficient than remote RMI. If they are on different machines, but there is no firewall in between then they can use EJB remote interface with remote RMI. Finally, if there exists a firewall between the client and the service, then they must communicate through SOAP over HTTP. These binding selection rules can be encoded as a set of static policy rules that the binding selection module can refer. The policy evaluation module (not shown in FIG. 1) may reside inside the binding selection module 108 or may be outside the binding proxy.

For certain bindings and applications, static policy rules may not be adequate for selecting the best binding. In this case, the binding selection algorithm may need to be implemented inside the binding selection module. One such case is the decision between a SOAP binding and an RMI binding for large messages. Embodiments of the invention analyze the correlation of the response time and the message size on the wire. In particular, it has been reported that there are cases when we can estimate the response time performance by statically estimating the average message to be exchanged between the client and the server. The following presents estimation of message size by analyzing the message structure.

SOAP Message Structure

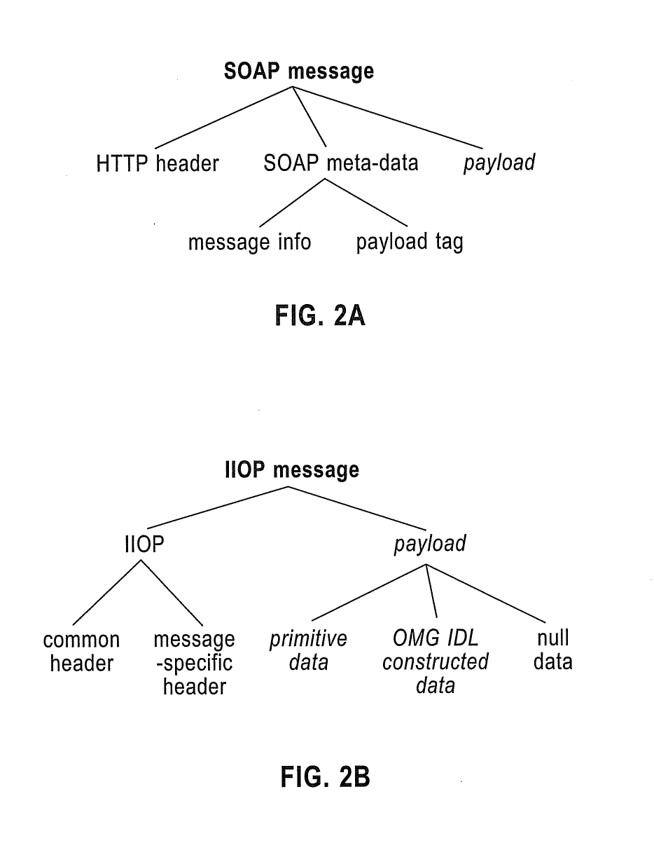

As seen in FIG. 2A a SOAP message is structured with three main parts: HTTP header, SOAP metadata, and payload. Empirically, it has been found that the size of HTTP headers varies in a small range Thus, in an embodiment of the invention, the HTTP headers are treated as a constant. The SOAP metadata can be further divided into two parts: message information (e.g., header information and name space) and payload tags. The size of these fields can also be either treated as constants, or obtained from a WSDL file. Finally, the size of payload data is a sum of all data length.

S_{SOAP}_{_{—}}_{payload}=ΣL(dᵢ),

where dᵢ is an element of a set, D, which contains all payload data that appear in a message, and L(dᵢ) is the length of a payload data in terms of byte. For example, L(“Paul Smith”)=10, L(3.1415)=6, and L(2005-12-25)=10. This is a variable part in the message, which cannot be determined by the static information in WSDL.

RMI-IIOP Message Structure

FIG. 2B illustrates the structure of an RMI-IIOP message consisting of two main parts: IIOP header and payload. An IIOP header consists of message ID, version, and a variable part that depends on the message type (e.g., request, reply, cancel request). The size of IIOP headers can be treated as constants for embodiments of the invention since their size is typically small with a small variance. The size of payload can be divided into three parts: GIOP primitive type data (e.g. octet, short, long), OMG IDL constructed types, and null data. The size of primitive type data can be simply computed by counting how many data instances occur in an RMI message, as follows:

Sₚᵣᵢₘᵢₜᵢᵥₑ_{_{—}}_{type}=Σ[N(typeᵢ)×S(typeᵢ)],

where N(typeᵢ) is the number of occurrences of typeᵢ data and S(typeᵢ) is the size of a typeᵢ data value. The size of fixed data types can be calculated from WSDL. However, an actual data value is required to calculate the size for variable length data, such as string.

Constructed data defined by the OMG IDL supports complex data types (e.g., structure, array, etc.). When a constructed data type object first appears in a message, several fields about type definition must be inserted such as codebase URL, and type name, which are mostly constant. When the same type of constructed data objects appear more than once in a message, the later occurrence refers to the original type definition. Finally, each null data consumes fixed 4 bytes in an IIOP message.

Performance Predictor Design

In general, both SOAP and RMI messages consists of three parts: (1) constant part, (2) variable part that can be calculated from the static information, and (3) variable part that cannot be calculated from the static information, such as payload data. The first two parts can be determined from the interface definition. However, the third one must be determined in some other way, and thus requires further discussion.

There are two ways to estimate the size of the variable parts. The first one is a grey box approach that uses general hints for a given service type. For example, when a client for a bank application is deployed, a general parameter space is used that has been derived from some other bank services. While the new application may exhibit different workload characteristics, this approach may be useful in practice. The second approach tries to estimate the size using some default value range that is large enough to cover most probable cases. This approach is useful for primitive types (e.g. numbers) since they have clear bounds. For complex types, e.g. arrays and strings, we can place an upper bound from empirical values or from a reasonable limit on the maximum message size. This approach is effective since most business applications exchange relatively small message size.

Once a total value space for the variable data types has been obtained, an estimation algorithm for average message size can be derived. This estimation algorithm will effectively predict the performance of the bindings. In this embodiment, a very simple algorithm that takes a majority vote on all the message size estimates on the entire parameter space is employed. For example, if the number of size estimate that RMI message will be smallest is f(RMI), that of SOAP will be smaller is f(SOAP), and that of JCA will be smaller is f(JCA), then the predictor simply chooses the binding with the arginax f(x). Although this operation may sound expensive, especially for a large parameter space, simple mathematical techniques can be employed, e.g. linear predictive analysis, to obtain the fast results without incurring repeated calculations. We note that this performance prediction result will be combined with the static rule before making the final decision.

Embodiments of the configuration discovery module may employ various techniques to detect the relative location and the existence of a firewall. The configuration discovery module can determine when a client and a service are contained in the same EAR file, since in this case the client is deployed with the service. The configuration discovery module can also detect whether the client and service are in the same JVM or not by using a utility such as javax.rmi.CORBA.Util.isLocal. Whether a client and a service are on the same subnet can be determined from the subnet mask. The existence of a firewall can be determined by sending a few probe messages to the RMI port. In the algorithm of Table 3, when there is no firewall between the client and the service, the algorithm of the configuration discovery module examines the message size and bases its decision on the message size estimation. In this case, if the history information is available from the service or from some external sources, it will estimate the average message size using this history. Otherwise, it will try to estimate which binding is more promising by trying out parameter values in the sample space. Table 2 is a simple version of such a module, which makes a decision based on majority. In other words, if RMI is predicted to perform better for a greater number of parameter points, then the configuration module selects RMI; otherwise it selects SOAP. One noteworthy aspect of this algorithm is that it will work robustly as long as there is a relative order of message sizes between RMI and SOAP irrespective of their absolute values.

TABLE 2

```
BindingSelection (locationInfo, existsFirewall) {
if (locationInfo == same_EAR) OR
  (locationlnfo == same_classlaoder) then
    return EJB_local_binding;
if (locationlnfo == same_JVM) then
    return EJB_remote_binding_with_local_RMI;
if (existsFirewall == false) then {
  if (history_exists == true) {
          if (Estimated_RMI msg_size(history)
        <Estimated_SOAP_msg_size(history))
      return EJB_remote_binding_with_remote_RMI;
  else
          return SOAP_binding;
  }
  else {
        return
  }  Estimate_with_no_history ( );
else
        return
}
```

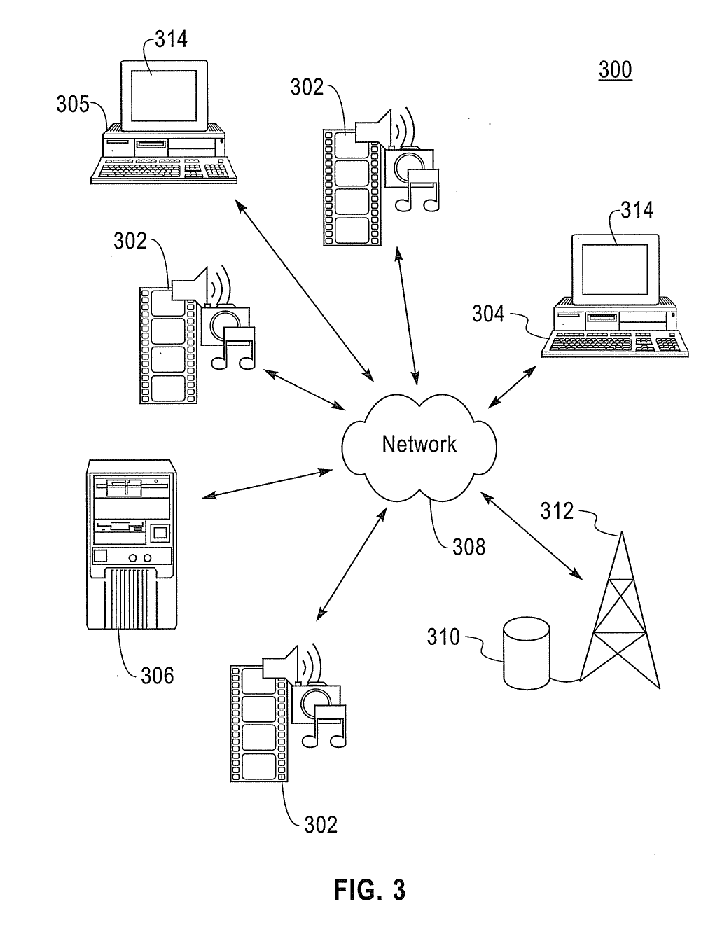

FIG. 3 is a block diagram of an exemplary system 300 for implementing the selection of the best performing binding for a service client in a service-oriented architecture using the environment information during deployment time or run time of the present invention and graphically illustrates how those blocks interact in operation. The system 300 includes remote devices including one or more multimedia/communication devices 302. In addition, mobile computing devices 304 and desktop computing devices 305 equipped with displays 314 for use with the present invention are also illustrated. The remote devices 302 and 304 may be wirelessly connected to a network 308. The network 308 may be any type of known network including a local area network (LAN), wide area network (WAN), global network (e.g., Internet), intranet, etc. with data/Internet capabilities as represented by server 306. Communication aspects of the network are represented by cellular base station 310 and antenna 312. Each remote device 302 and 304 may be implemented using a general-purpose computer executing a computer program for carrying out the program described herein. The computer program may be resident on a storage medium local to the remote devices 302 and 304, or maybe stored on the server system 306 or cellular base station 310. The server system 306 may belong to a public service. The remote devices 302 and 304, and desktop device 305 may be coupled to the server system 306 through multiple networks (e.g., intranet and Internet) so that not all remote devices 302, 304, and desktop device 305 are coupled to the server system 306 via the same network. The remote devices 302, 304, desktop device 305, and the server system 306 may be connected to the network 308 in a wireless fashion, and network 308 may be a wireless network. Alternatively, the remote devices 302 and 304 may be implemented using a device programmed primarily for accessing network 308 such as a remote client.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for selecting a best performing binding for a server and a client in a service-oriented architecture wherein the method comprises:
discovering configuration information about the service and the operating environment of the server and the client;
selecting the best performing binding between the client and the server based on the discovered information;
enabling the selected binding in a binding proxy for communication between the client and the server.

2. The method of claim 1, wherein:
a binding selection module communicates with a configuration discovery module to determine the best performing binding.

3. The method of claim 1, wherein:
the forming of the binding proxy is based on Web Services Description Language (WSDL) from the service.

4. The method of claim 1, wherein:
the determining of the best performing binding is facilitated by a set of static policy rules encoded in a binding selection module.

5. The method of claim 1, wherein:
the determining of the best performing binding is facilitated by an algorithm in a binding selection module that estimates message size to be exchanged between the client and the server.

6. The method of claim 1, wherein the collected information about the operating environment comprises one or more of the following:
relative location of the client and the service;
information about execution environment;
existence of firewalls between the client and the service; and
existence of physical or virtual network devices between the client and the service.

7. A system for selecting the best performing binding for a service and client in a service-oriented architecture using environment information during deployment time or run time, the system comprising:
a configuration discovery module that collects information about an operating environment;
a binding proxy to select the best performing binding among multiple alternatives between service client and server based on the collected information from the configuration discovery module;
a binding selection module that contains the decision logic and implements the bindings, and interacts with the configuration discovery module;
a binding proxy interface that automatically creates a binding proxy containing multiple bindings while exposing a unified interface;
wherein the multiple bindings are created based on WSDLs published by the service;
a stub module that facilitates a client module to connect to a remote service using one of the multiple bindings, while presenting a uniform programming interface to a programmer;
an automated generator for forming stubs based on collecting information about possible bindings that a service can receive; and
decision logic inside the formed stub that communicates with the configuration discovery module to determine the optimal binding for the client and the service.

8. An article comprising machine-readable storage media containing instructions that when executed by a processor enable the processor to selecting the best performing binding for a service and client in a service-oriented architecture using environment information during deployment time or run time, wherein the instructions comprise:
collecting information about an operating environment by a configuration discovery module;
determining a best performing binding between a client service and a server with decision logic based on the collected information from the configuration discovery module;
implementing the best performing binding with a binding proxy module; and
forming stubs by an automated generator based on collected information about possible bindings that the client service can receive.

9. The article of claim 8, wherein:
decision logic inside the formed stubs communicates with the configuration discovery module to determine the optimal binding.

10. The article of claim 8, wherein:
the forming of the stubs is based on Web Services Description Language (WSDL) from the client service.

11. The article of claim 8, wherein:
the determining of a best performing binding is facilitated by an algorithm in the configuration discovery module that examines message size and bases its decision on a message size estimation.

12. The article of claim 8, wherein the collected information about the operating environment comprises:
the relative location of the client and the service; and
the existence of a firewall between the client and the service.
